(19) United States
(12) Patent Application Publication
(10) Pub. No.: US 2012/0207457 A1
(43) Pub. Date: Aug. 16, 2012

(54) IMAGE STABILIZATION APPARATUS, AND CONTROL METHOD FOR SAME

(75) Inventor: Kenichi Miyasako, Tokyo (JP)

(73) Assignee: CANON KABUSHIKI KAISHA, Tokyo (JP)

(21) Appl. No.: 13/357,136

(22) Filed: Jan. 24, 2012

(30) Foreign Application Priority Data
Feb. 16, 2011 (JP) 2011-030453

(51) Int. Cl. G03B 17/00

(52) U.S. Cl. 396/55

(57) ABSTRACT

An angular velocity sensor detects shake applied to an imaging apparatus. A HPF calculation unit attenuates low-frequency components in the output of the angular velocity sensor. An image blur compensation amount is calculated based on that output, and image blur compensation is executed by drive control of the compensation optical system. An intermediate value is retained as a calculation results for each sampling period by the digital filter that configures the HFP calculation unit. When the panning control unit that detects a panning operation by the imaging apparatus detects the completion of a panning operation, the intermediate value retained in the digital high pass filter is initialized by the panning control unit.

### BACKGROUND OF THE INVENTION

1. Field of the Invention

The present invention relates to an image stabilization apparatus including a function for compensation of image blur resulting from hand motion or the like, and to a control method for the same.

2. Description of the Related Art

With recent advances in downsizing of an imaging apparatus or in enhancing the magnification of an optical system, shake of the imaging apparatus or the like have caused a reduction in image quality. Various proposals related to this point have been made in relation to an image blur compensation function for compensation of shake in a captured image as a result of shake or the like of the apparatus.

The imaging apparatus disclosed in Japanese Patent Application Laid-Open No. 6-90400 is configured to correct image blur by displacing a correction lens to cancel out the detection output of an angular velocity sensor. A detection signal of the angular velocity sensor includes a direct current component (offset component) even when an applied vibration is zero. Consequently, calculation of the original angular velocity applied to the imaging apparatus requires elimination of offset from the detection output for angular velocity by use of a high pass filter (HPF) or the like. However, when a large shaking is caused by panning or the like of the imaging apparatus, the following conditions may result in relation to a method using a high pass filter.

Although offset components that are steadily produced by the angular velocity sensor are eliminated by passage through the HPF, low-frequency components during panning are also attenuated, and as a result, a signal in the opposite direction to the panning direction is produced at completion of a panning operation. Thereafter, this signal slowly converges to a value of zero. When correcting image blur in accordance with this output, there is a risk of a user being subjected to uncertainty since a phenomenon occurs in which the image moves (a so-called swing-back phenomenon) irrespective of an absence of shake in the imaging apparatus. Japanese Patent Application Laid-Open No. 6-90400 discloses a method for avoiding the swing-back phenomenon by retaining an image blur compensation member in a modified state after a panning operation.

However, although the conventional technique disclosed in Japanese Patent Application Laid-Open No. 6-90400 enables suppression of a swing-back phenomenon in a period until an HPF output converges to zero after completion of a panning operation, the conventional technique does not enable image blur compensation.

### SUMMARY OF THE INVENTION

The present invention provides an image stabilization apparatus that reduces or prevents a swing-back phenomenon after a panning operation without suspension of image blur compensation.

In view of the foregoing, an apparatus according to the present invention corrects image blur by use of an image blur compensation member, and includes a shake detection unit configured to detect shake of an imaging apparatus, a filter unit configured to attenuate a low-frequency component of an output of the shake detection unit, a compensation control unit configured to calculate an image blur compensation amount based on an output of the filter unit, and to control the image blur compensation unit, and a determination unit configured to determine whether an operation for varying the imaging direction of the imaging apparatus has been performed. The filter unit retains an intermediate value as a calculation result for each sampling period. When the determination unit detects completion of an operation for varying the imaging direction, the filter unit initializes the intermediate value and places the output to approximately a value of zero. According to the present invention, a swing-back phenomenon after a panning operation can be reduced or prevented without suspension of image blur compensation.

Further features of the present invention will become apparent from the following description of exemplary embodiments with reference to the attached drawings.

### BRIEF DESCRIPTION OF THE DRAWINGS

FIG. 1 is a block diagram illustrating a configuration example of an imaging apparatus to describe an aspect of the present exemplary embodiment.

FIG. 2 is a block diagram illustrating a configuration example of an HPF calculation unit 107 in FIG. 1.

FIG. 3 is a flowchart illustrating a processing example executed by a panning control unit 110 in FIG. 1 to describe a first aspect of the present invention.

FIGS. 4A and 4B describe the processing in FIG. 3.

FIG. 5 is a flowchart illustrating a processing example executed by the panning control unit 110 to describe a second aspect of the present invention.

FIGS. 6A, 6B and 6C describe the processing in FIG. 5.

### BRIEF DESCRIPTION OF THE EMBODIMENTS

The preferred embodiments of the present invention will be described in detail below with reference to the figures. Since the same compensation processing for image blur is applied in the horizontal and vertical directions of the image, the following description will only relate to image blur compensation control in a horizontal direction of the image. Furthermore, an example of a panning operation will be used to describe an operation for varying the imaging direction of the imaging apparatus (such as a panning operation, tilting operation or the like).

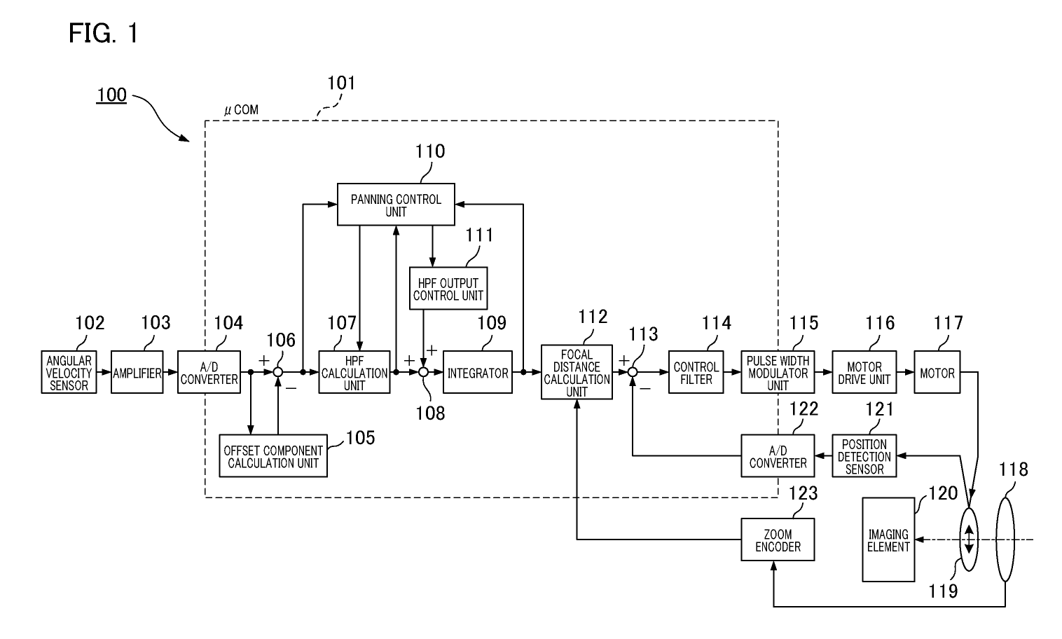

FIG. 1 is a block diagram illustrating a configuration example of a digital video camera as an example of an imaging apparatus that includes an image blur compensation according to a first aspect of the present invention.

An angular velocity sensor 102 executes shake detection applied to an imaging apparatus. For example, shake of the imaging apparatus itself due to hand shaking or swinging of the body can be detected by use of an angular velocity sensor of a vibration gyro. An amplifier 103 amplifies a detection signal from the angular velocity sensor 102 to a suitable sensitivity and outputs the signal to the A/D converter 104. The A/D converter 104 digitalizes the output of the amplifier 103 and supplies the signal to a subtracter 106 in an inner portion of a control unit 101 (refer to μCOM in FIG. 1). In the following description, the output signal of the A/D converter 104 is referred to as an “angular velocity sensor signal”.

The output (offset component) of the angular velocity sensor 102 exhibits a unique difference when the imaging apparatus is in a stationary state, that is to say, when the applied vibration is zero. Furthermore, the offset component varies in response to the environment. The angular velocity sensor signal is a signal in which an offset component is superimposed on a signal showing the shake of the imaging apparatus 100. An offset component calculation unit 105 functions as a calculation unit and calculates the output of the A/D converter 104 when the vibration applied to the angular velocity sensor 102 is zero, that is to say, the offset component, and outputs the result to the subtracter 106. The method of calculating the offset includes a method of calculating a moving average of an angular velocity sensor signal or a method of applying a low-pass filter (LPF) process to the angular velocity sensor signal. The subtracter 106 may omit by subtracting the offset component calculated by the offset component calculation unit 105 from the angular velocity sensor signal, and output a first signal showing the difference (hereinafter referred to as “angular velocity signal”) to the HPF calculation unit 107.

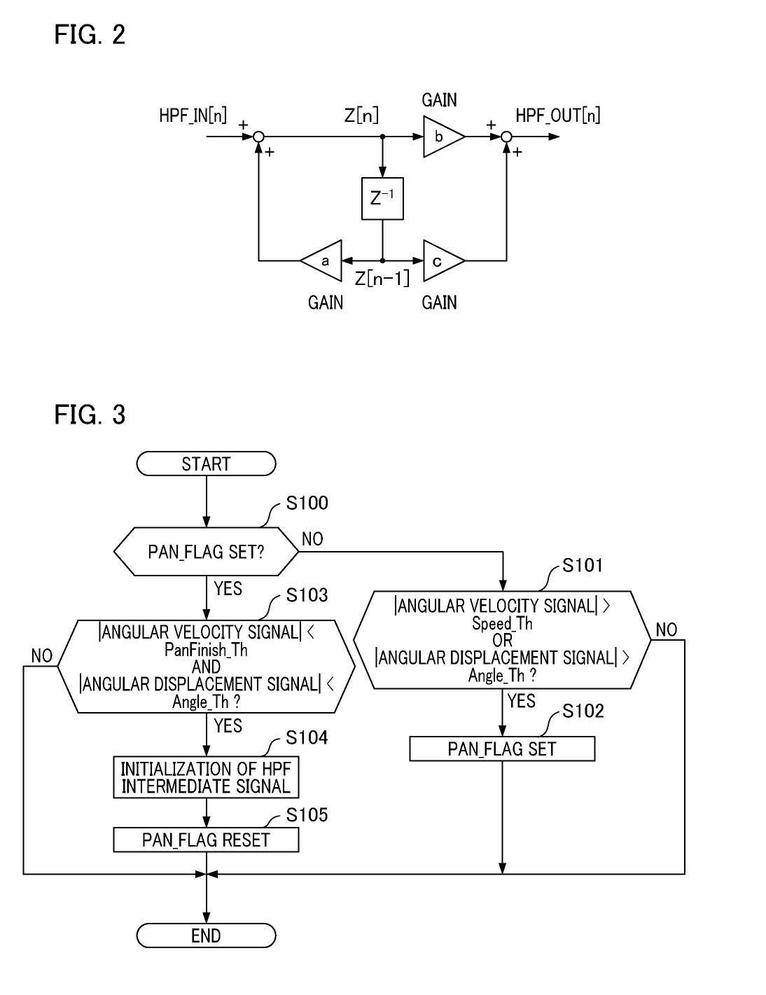

FIG. 2 illustrates a recursive digital high-pass filter as a configuration example of the HPF calculation unit 107 provided as a filter unit. A gain a, b, c illustrates a multiplication element in which the coefficients a, b, c are multiplied by an input signal, and outputted. Furthermore, Z⁻¹ illustrates a delay element in which an input signal is delayed by one sampling time, and outputted. An input signal in an nth sampling time in the HPF calculation unit 107 is denoted as HPF_IN [n], and the output signal is denoted as HPF_OUT [n]. When the signal supplied to the delay element (hereinafter referred to as HPF intermediate signal, and including the HPF intermediate value) is denoted as Z[n], HPF_OUT [n] and Z[n] can be represented in the following equation.

HPF_OUT[n]=b×Z[n]+c×Z[n−1] Equation 1

Z[n]=HPF_IN[n]+a×Z[n−1] Equation 2

The HPF calculation unit 107 repeats the calculation in Equation 1 and Equation 2 to thereby attenuate and output the low-frequency component of a signal inputted from the subtracter 106. In other words, the HPF calculation unit 107 functions as a filter unit having a high pass filter configured to attenuate a low-frequency component of an output of the shake detection unit.

An adder 108 adds an output signal from an HPF output control unit 111 to an output signal from the HPF calculation unit 107 and supplies the resulting signal to an integrator 109. The integrator 109 integrates the output signals from the adder 108 and outputs a second signal (hereinafter referred to as “an angular displacement signal”).

The panning control unit 110 functions as a determination unit and uses the angular velocity signal outputted by the subtracter 106 or the angular displacement signal outputted by the integrator 109 to execute an operational determination of whether or not the imaging apparatus 100 is in a panning state. After determining that the apparatus 100 is in a panning state, when it is determined that the panning operation is completed, the panning control unit 110 executes a predetermined control operation on the HPF calculation unit 107 and the HPF output control unit 111. The control during completion of the panning operation will be described in detail below. A method of determining whether or not an output of the subtracter 106 or the integrator 109 exceeded a predetermined threshold may be used in relation to the determination of a panning state.

A circuit portion below the integrator 109 configures an image blur compensation amount calculation unit that functions as a compensation control unit and calculates the image blur compensation amount. A focal distance calculation unit 112 acquires current zoom position information to thereby calculate the focal distance. A zoom encoder 123 for detecting a zoom position is provided in the imaging optical system 118 that executes a zoom or focus operation, and enables acquisition of zoom position information. The focal distance calculation unit 112 uses the focal distance information and the angular displacement signal to calculate a compensation driving amount for the compensation optical system 119. In the following description, the output of the focal distance calculation unit 112 is referred to as an “image blur compensation signal”, and the signal is sent to the subtractor 113. A signal is inputted to the subtractor 113 from the position detection sensor 121 through an A/D converter 122. The position detection sensor 121 detects the position of the compensation optical system 119 that functions as an image blur compensation member having a correction lens, and outputs a signal (hereinafter referred to as a “position detection signal”) in which the output of the sensor 121 is digitalized by the A/D converter 122. A difference signal in which a position detection signal is subtracted in the subtractor 113 from the image blur compensation signal is sent to a control filter 114 for processing, and a pulse width modulation unit 115 converts the output of the control filter 114 to a pulse width modulation (PWM) signal. A motor drive unit 116 drives a motor 117 in accordance with the PWM output from the pulse width modulation unit 115, and drives the compensation optical system 119. In this manner, the compensation optical system 119 moves in a direction that is orthogonal to the optical axis, the angle of incidence onto the imaging surface of an imaging element 120 is varied such that correct image blur is optically corrected. Furthermore, the present example uses a configuration of driving the compensation optical system 119 as an image blur compensation member for correcting image blur.

### First Exemplary Embodiment

The operation of the panning control unit 110 according to a first exemplary embodiment of the present invention will be described hereafter. In the present exemplary embodiment, an output of the HPF output control unit 111 in FIG. 1 is deemed to always have a value of zero, or the HPF output control unit 111 and the adder 108 are deemed to be omitted.

FIG. 3 is a flowchart illustrating a processing example executed by a panning control unit 110. The present process is repeated at a predetermined period of 1/1000 sec for example. Detailed description is provided below.

S100 is a process of determining whether or not the imaging apparatus 100 is in a panning state. When a determination flag is denoted as PAN_FLAG, the flag is determined to be set or not. When the flag is set, the processing proceeds to S103, and when the flag is not set, the processing proceeds to S101.

In S101, the absolute value of the angular velocity signal that is the output of the subtractor 106, or the absolute value of the angular displacement signal that is the output of the integrator 109, is compared with a predetermined determination threshold. When the absolute value of the angular velocity signal is greater than a panning commencement determination threshold (denoted as “Speed_Th”), or when the absolute value of the angular displacement signal is greater than a panning determination threshold (denoted as “Angle_Th”), the processing proceeds to S102. On the other hand, when the absolute value of the angular velocity signal is less than Speed_Th, or when the absolute value of the angular displacement signal is less than Angle_Th, that is to say, when the imaging apparatus 100 is determined not to be in a panning state, the processing is stopped. In S101, when the imaging apparatus 100 is determined to be in a panning state, after the PAN_FLAG is set in S102, the processing is stopped.

In S103, the absolute value of the angular velocity signal is compared with a panning completion determination threshold (denoted as “PanFinish_Th”), and the absolute value of the angular displacement signal is compared with a panning determination threshold (denoted as “Angle_Th”). The panning completion determination threshold PanFinish_Th is smaller than the panning commencement determination threshold Speed_Th. Furthermore, PanFinish_Th is set to a value close to zero, and when the absolute value of the angular velocity signal is less than PanFinish_Th, it means that the shaking amount applied to the imaging apparatus 100 is approximately zero. When it is determined that the absolute value of the angular velocity signal is less than PanFinish_Th, and the absolute value of the angular displacement signal is smaller than Angle_Th, the processing proceeds to S104. On the other hand, when it is determined that the absolute value of the angular velocity signal is greater than PanFinish_Th, or the absolute value of the angular displacement signal is greater than Angle_Th, that is to say, when it is determined that the imaging apparatus 100 is determined to be in a panning state, the processing is stopped.

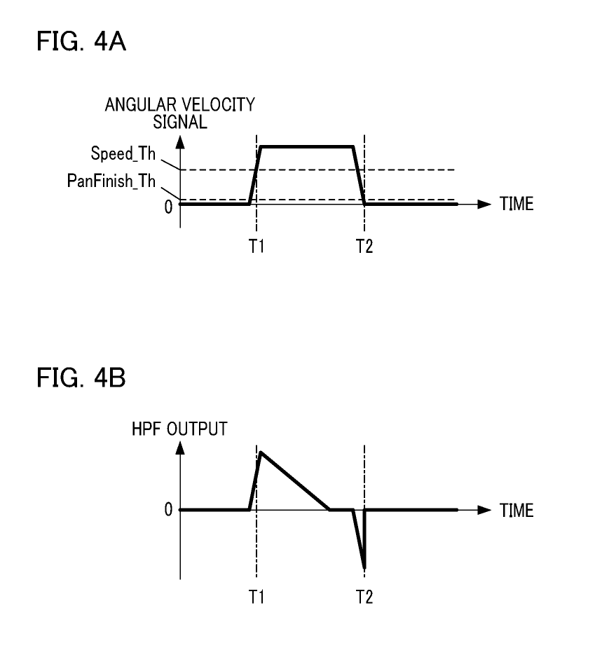

In step S104, an initialization process for the intermediate signal Z[n−1] of the HPF calculation unit 107 shown in FIG. 2 is executed, and Z[n−1] is set to a value of zero. The initialization process will be described in detail making reference to FIGS. 4A and 4B.

FIG. 4A is a graph illustrating an example of temporal variation in an angular velocity signal when a panning operation is executed by the imaging apparatus 100. FIG. 4B is a graph illustrating an example of the output after the angular velocity signal in FIG. 4A passes through the HPF calculation unit 107. For the purposes of simplicity, although the figures only illustrate an extracted waveform of a signal detecting a panning operation, actually, high-frequency hand-shake components form a superimposed waveform on the graphs illustrated in FIGS. 4A and 4B.

In FIG. 4A, the angular velocity signal exceeds the panning commencement determination threshold Speed_Th at a time T1, and at S101 in FIG. 3, it is determined that the panning operation commences. Thereafter, at a time T2, when the angular velocity signal is smaller than the panning completion determination threshold PanFinish_Th, in S103 in FIG. 3, it is determined that the panning operation is completed. In S104 in FIG. 3, when the intermediate signal of the HPF calculation unit 107, that is to say, when the intermediate value that is retained as a calculation results for each sampling time is initialized, the output of the HPF calculation unit 107 varies as shown below.

In Equation 2, when a value of 0 is substituted into Z[n−1], the equation is rewritten as shown below.

Z[n]=HPF_IN[n] Equation 3

When substituting Z[n−1]=0 and Equation 3 into Equation 1, the following equation is obtained.

HPF_OUT[n]=b×HPF_IN[n] Equation 4

Since the angular velocity signal at the time T2 is a smaller value than the panning completion determination threshold PanFinish_Th, and “HPF_IN [n]≈0”, Equation 4 becomes “HPF_OUT [n]≈0”. That is to say, when the intermediate signal of the HPF calculation unit 107 is initialized at the time T2, as illustrated in FIG. 4B, the output of the HPF calculation unit 107 is approximately zero. In this manner, notwithstanding the fact that the imaging apparatus does not operate after completion of the panning operation, a swing-back phenomenon in which a signal is produced in the HPF output can be prevented. After S104 in FIG. 3, the processing proceeds to S105, the PAN_FLAG is reset, and the processing is completed. In this manner, according to the first exemplary embodiment, a swing-back phenomenon that is caused by HPF can be inhibited in an imaging apparatus that includes a compensation function for image blur resulting from hand movement. Furthermore, unnatural image movement after completion of panning can be prevented. That is to say, there is no requirement to stop the image blur compensation in response to a swing-back phenomenon after completion of panning.

### Second Exemplary Embodiment

A second exemplary embodiment of the present invention will be described hereafter.

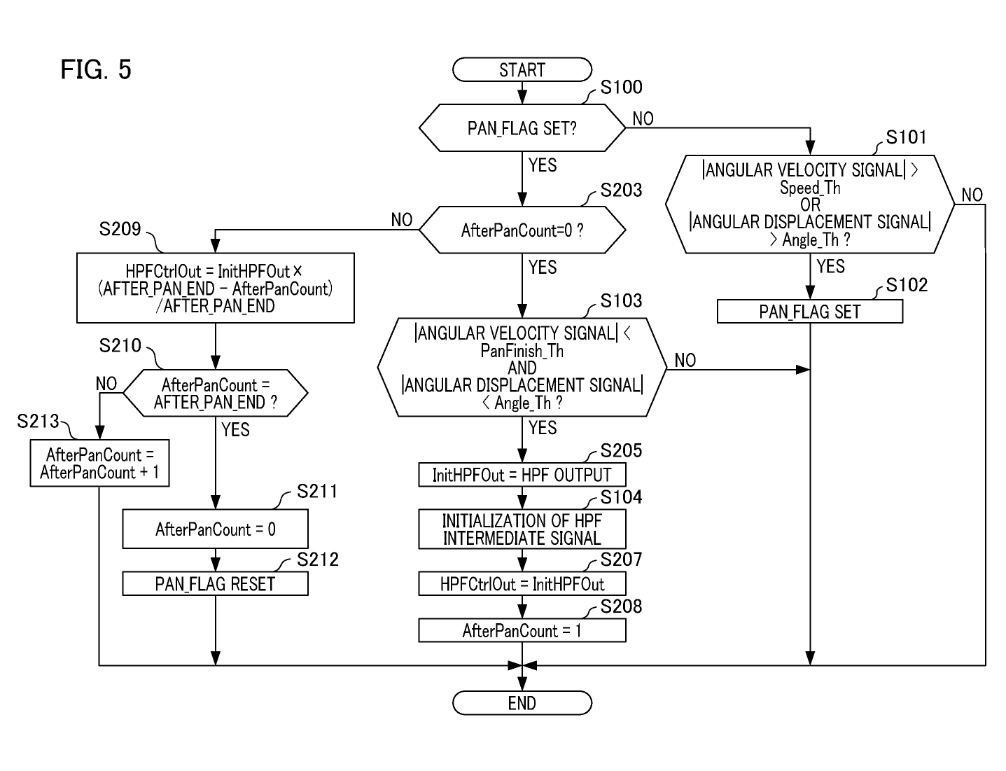

FIG. 5 is a flowchart illustrating a processing example executed by a panning control unit 110. The description below will focus on S203, S205, and S207 to S213 that differ from FIG. 3. Those processing steps that are the same as FIG. 3 are denoted by the step numbers already used above, and detailed description of those steps will not be repeated.

When the PAN_FLAG is set in S100, the processing proceeds to S203, and it is determined whether or not the variable for measurement of the time after completion of the panning operation (denoted as AfterPanCount) has a value of zero. When the value of AfterPanCount is determined to be zero, it is shows a state in which the determination that the panning is completed has not been performed, and the processing proceeds to the processing in S103 (completion determination process for panning operation).

In S103, when it is determined that the absolute value of the angular velocity signal is smaller than the panning completion determination threshold PanFinish_Th, and that the absolute value of the angular displacement signal is smaller than the panning determination threshold Angle_Th, the processing proceeds to S205. In S205, a process is executed in which the output of the HPF calculation unit 107 immediately after the execution of the determination that the panning operation is completed is stored as a variable (denoted as InitHFPOut), and the processing proceeds to S104. The initialization process for the intermediate signal Z[n−1] of the HPF calculation unit 107 is executed and the processing proceeds to S207. In S207, a process is executed in which the value of the variable InitHFPOut above is substituted for a variable that shows the output of the HPF output control unit 111 (denoted as HPFCtrlOut). That is to say, the output of the HPF output control unit 111 is set to the same value as the output of the HPF calculation unit 107 immediately after execution of the determination that the panning operation is completed. In the present example, although the setting of the process is such that “HPFCtrlOut=InitHFPOut”, the invention is not limited in this regard, and the value that is set as HPFCtrlOut may be a value close to InitHFPOut. After S207, the processing proceeds to S208, and after the value for the variable AfterPanCount is set to a value of 1, the processing is stopped. In the processing step after “AfterPanCount=1”, a determination of NO in S203 is given, and the processing proceeds to S209. In S209, the output HPFCtrlOut of the HPF output control unit 111 is calculated using the following equation.

HPFCtrlOut=InitHPFOut×(AFTER_PAN_END−AfterPanCount)/AFTER_PAN_END Equation 5

In Equation 5, in response to the passage of time, the variable AFterPanCount takes a value from 1 to AFTER_PAN_END (>0). As the value of the variable AFterPanCount increases, the value for HPFCtrlOut decreases, and when the value of the variable AfterPanCount reaches AFTER_PAN_END, HPFCtrlOut=0.

Next in S210, it is determined whether or not the value for the variable AfterPanCount is equal to AFTER_PAN_END. When the value for the variable AfterPanCount has not reached AFTER_PAN_END, the processing proceeds to S213, and after a value of 1 is added to the variable AfterPanCount, the process is stopped. The processing in S210 and S213 enables the value of the variable AfterPanCount to be increased successively by a value of 1 when the processing in the flowchart illustrated in FIG. 5 is repeated. In this manner, after an initial value InitHPFOut is set using Equation 5 in S207, the output of the HPF output control unit 111 converges towards zero on each occasion the processing in S209 is executed. When AfterPanCount=AFTER_PAN_END, HPFCtrlOut takes a value of zero. When it is determined in S210 that the value of the variable AfterPanCount has reached AFTER_PAN_END, the processing proceeds to S211. In S211, the value of the variable AfterPanCount is initialized to zero, and after the PAN_FLAG is reset in S212, the processing is stopped.

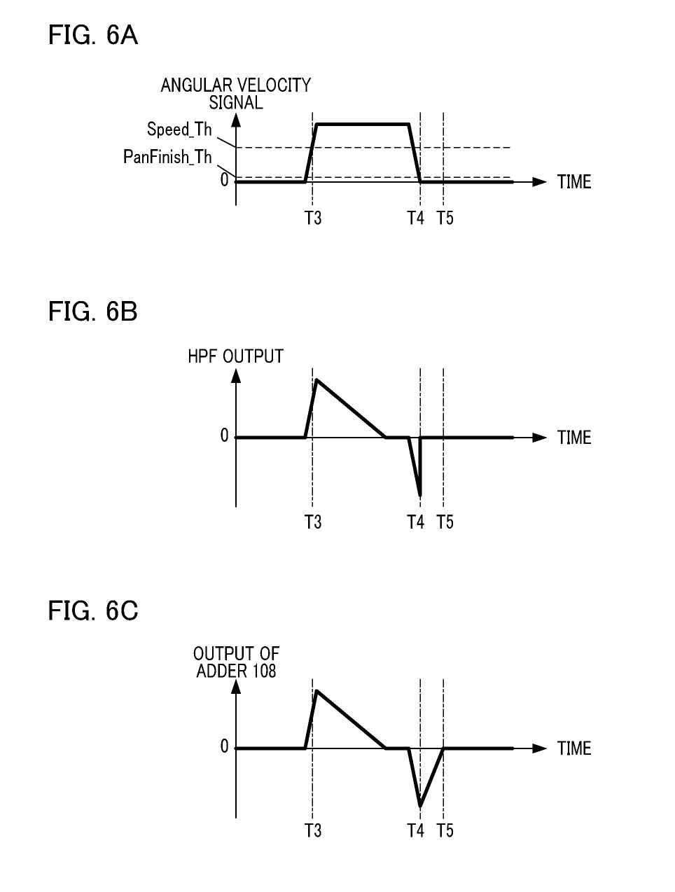

The reason that the output of the HPF output control unit 11 gradually converges to a value of zero from the initial value InitHPFOut as a result of the processing in S207 and S209 will be described making reference to FIGS. 6A, 6B, and 6C.

FIG. 6A is a graph illustrating an example of the temporal variation in an angular velocity signal when the panning operation is executed by the imaging apparatus 100. FIG. 6B is a graph illustrating an example of the output after angular velocity signal in FIG. 6A passes through the HPF calculation unit 107. FIG. 6C is a graph illustrating an example of the output after the output of the HPF output control unit 11 is added by the adder 108 to the output of the HPF calculation unit 107. For the purposes of simplicity, although the figures only illustrate an extracted waveform of a signal detecting a panning operation, actually, high-frequency hand-shake components form a superimposed waveform on the graphs illustrated in FIGS. 6A, 6B and 6C.

In FIG. 6A, it is determined that the panning operation has commenced when the angular velocity signal exceeds the panning commencement determination threshold Speed_Th at a time T3. Thereafter, at a time T4, when the angular velocity signal is smaller than the panning completion determination threshold PanFinish_Th, it is determined that the panning operation is completed. As illustrated in FIG. 6B, S104 in FIG. 5 (initialization of the intermediate signal of the HPF calculation unit 107) causes the output of the HPF calculation unit 107 at a time T4 to take a value of approximately zero. When the output of the HPF calculation unit 107 illustrated in FIG. 6B is supplied to the integrator 109 without passing through the adder 108, the same effect as that described in relation to the first exemplary embodiment is obtained. In other words, after completion of panning, the image that was moving in accordance with the panning operation immediately stops. However, although no adverse effect is imparted to this image when a low-speed panning operation is executed, if a relatively rapid panning operation is executed, there is the possibility that a rapidly stopping image will cause concern to a user.

In this content, as illustrated in FIG. 6C, in the second exemplary embodiment, the processing in S207 and S209 in FIG. 5 acts as control from the time T4 to the time T5 to make the output of the HPF output control unit 111 that functions as an output control unit gradually approach zero. That is to say, the output gradually converges from the output value of the HPF calculation unit 107 immediately after the completion of the panning operation to a value of zero. In this manner, an image that gradually slows after the panning operation is obtained. The deceleration period from the time T4 to the time T5 in FIG. 6C is determined by the dimension of AFTER_PAN_END in Equation 5. The value for AFTER_PAN_END may be a fixed value or may be a value that varies in response to the velocity of the panning operation. For example, a setting process may be executed in which the value for AFTER_PAN_END increases as the panning velocity increases. In this manner, the deceleration time until the HPF output reaches zero is controlled, and the effect of a swing-back phenomenon can be reduced.

In accordance with the second exemplary embodiment, an image blur compensation reduces speed without stopping in contrast to a swing-back phenomenon after a panning operation, and high quality image blur compensation is realized by smooth stopping of the resulting image.

While the embodiments of the present invention have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

For example, the compensation optical system 119 may be an electronic compensation member or may be configured to displace an imaging element 120. Furthermore, in substitution for the angular velocity sensor 102, execution by a variety of configurations is possible for example by use of a vibration detection unit such as an acceleration sensor or the like. The present invention has been described in relation to a digital video camera as an example of an imaging apparatus. However application is also enabled in relation to optical equipment such as a digital still camera or a digital single lens reflex camera, or an interchangeable lens used in such equipment.

While the embodiments of the present invention have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-030453 filed Feb. 16, 2011 which is hereby incorporated by reference herein in its entirety.

What is claimed is:

1. An image stabilization apparatus configured to compensate for an image blur with an image blur compensation member, the image stabilization apparatus comprising:
a shake detection unit configured to detect shake of an imaging apparatus;
a filter unit configured to attenuate a low-frequency component of an output of the shake detection unit;
a compensation control unit configured to calculate an image blur compensation amount based on an output of the filter unit, and to control the image blur compensation unit; and
a determination unit configured to determine whether an operation for varying the imaging direction of the imaging apparatus has been performed,
wherein the filter unit retains an intermediate value as a calculation result for each sampling period, and
wherein, when the determination unit detects completion of an operation for varying the imaging direction, the filter unit initializes the intermediate value and places the output to approximately a value of zero.

2. The image stabilization apparatus according to claim 1 further comprises an output control unit configured to execute control to store an output of the filter unit and gradually attenuate the output from the stored value or an approximate value thereto thereby converge the output to a value of zero, when the determination unit detects completion of an operation for varying the imaging direction.

3. The image stabilization apparatus according to claim 1 further comprises a calculation unit configured to calculate an offset component that is outputted by the shake detection unit when the imaging apparatus is in a stationary state,
wherein the determination unit determines the completion of an operation for varying the imaging direction when a first signal that is the difference of the output of the shake detection unit and the offset component is smaller than a threshold value.

4. The image stabilization apparatus according to claim 3,
wherein the compensation control unit calculates a second signal by integrating the first signal, and
wherein the determination unit determines the initiation of an operation for varying the imaging direction of the imaging apparatus when the first signal is larger than the threshold value, or when the second signal is larger than the threshold value.

5. An optical apparatus including the image stabilization apparatus according to claim 1.

6. An image capture apparatus including the image stabilization apparatus according to claim 1.

7. A control method executed on an imaging apparatus that compensates image blur with an image blur compensation unit, the method comprising:
detecting, in a detecting step, shake of an imaging apparatus;
attenuating, in an attenuating step, a low-frequency component of an output of the shake detection unit with a filter unit in the detecting step;
calculating, in a calculating step, an image blur compensation amount by acquiring an output in the attenuating step; and
controlling, in a controlling step, the image blur compensation unit according to the image blur compensation amount in the calculating step,
wherein the filter unit retains an intermediate value as a calculation result for each sampling period; and in the attenuating step, when completion of an operation for varying the imaging direction is detected, the intermediate value is initialized and the output is placed to approximately a value of zero.
